(19) United States
(12) Patent Application Publication
(10) Pub. No.: US 2026/0200567 A1
(43) Pub. Date: Jul. 16, 2026

(54) ELECTRIC BOAT PROPULSION DEVICE AND BOAT

(71) Applicant: YAMAHA HATSUDOKI KABUSHIKI KAISHA, Iwata-shi (JP)

(72) Inventors: Keiichi SUETAKE, Shizuoka (JP); Kentaro TAKEDA, Shizuoka (JP)

(21) Appl. No.: 19/450,221

(22) Filed: Jan. 15, 2026

(30) Foreign Application Priority Data
Jan. 16, 2025 (JP) 2025-005874

(51) Int. Cl. B63H 20/12; B63B 79/10; B63H 1/14

(52) U.S. Cl. CPC B63H 20/12; B63B 79/10; B63H 1/14

(57) ABSTRACT

An electric boat propulsion device includes a cylindrical duct including a conductive wall defining an accommodation space, a propeller rotatably supported inside the duct and including a plurality of blades arranged around a propeller axis extending along a central axis of the duct, and a cylindrical rim surrounding the plurality of blades, an electric motor to rotate the propeller relative to the duct and including a stator on the duct and a rotor on the rim, and a circuit board including a contact region that contacts the conductive wall and a non-contact region that does not contact the conductive wall. The circuit board includes a rotation angle sensor to output a signal corresponding to a rotation angle of the rotor, and a circuit pattern in the non-contact region and not in the contact region.

### CROSS REFERENCE TO RELATED APPLICATIONS

This application claims the benefit of priority to Japanese Patent Application No. 2025-005874 filed on Jan. 16, 2025. The entire contents of this application are hereby incorporated herein by reference.

### BACKGROUND OF THE INVENTION

### 1. Field of the Invention

The techniques disclosed herein relate to electric boat propulsion devices and boats.

### 2. Description of the Related Art

A rim drive-type electric boat propulsion device is known. Such an electric boat propulsion device includes a cylindrical duct, a propeller rotatably supported inside the duct, an electric motor that rotates the propeller relative to the duct, and a circuit board. The propeller has a plurality of blades arranged around a propeller axis extending along a central axis of the duct, and a cylindrical rim that surrounds the plurality of blades. The electric motor has a stator provided on the duct and a rotor provided on the rim. On the circuit board, for example, various electronic components and circuit patterns for controlling the rotation of the electric motor are arranged (for example, see Japanese Patent Application No. 2013-100013).

### SUMMARY OF INVENTION

The inventors of example embodiments of the present invention considered using a configuration in which the duct includes a conductive wall in a rim drive-type electric boat propulsion device. When using such a configuration, there is room to discover how the relationship between the conductive wall of the duct and the circuit pattern of the circuit board affects the rim drive-type electric boat propulsion device.

Example embodiments of the present invention disclose techniques that are able to solve the problems described above.

The techniques disclosed herein can be implemented, for example, as the following example embodiments.

An electric boat propulsion device according to an example embodiment of the present invention includes a cylindrical duct including a conductive wall defining an accommodation space, a propeller rotatably supported in the duct and including a plurality of blades arranged around a propeller axis extending along a central axis of the duct, and a cylindrical rim surrounding the plurality of blades, an electric motor to rotate the propeller relative to the duct and including a stator on the duct and a rotor on the rim, and a circuit board including a contact region that contacts the conductive wall and a non-contact region that does not contact the conductive wall, wherein the circuit board includes a rotation angle sensor to output a detection signal corresponding to a rotation angle of the rotor, and a circuit pattern in the non-contact region and not in the contact region.

An electric boat propulsion device according to another example embodiment of the present invention includes a cylindrical duct including a conductive wall defining an accommodation space, a propeller rotatably supported in the duct and including a plurality of blades arranged around a propeller axis extending along a central axis of the duct, and a cylindrical rim surrounding the plurality of blades, an electric motor to rotate the propeller relative to the duct and including a stator on the duct and a rotor on the rim, and a circuit board including a contact region that contacts the conductive wall and a non-contact region that does not contact the conductive wall, wherein the circuit board includes a circuit pattern in the non-contact region and not in the contact region.

The techniques disclosed herein can be implemented in various example embodiments, for example, as electric boat propulsion devices, boat control systems including electric boat propulsion devices, boats including electric boat propulsion devices, and the like.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a perspective view schematically showing a configuration of a boat according to an example embodiment of the present invention.

FIG. 2 is a side view showing a configuration of an electric propulsion device.

FIG. 3 is a schematic diagram showing a configuration of a drive unit.

FIG. 4 is a block diagram showing a configuration of a boat control system in a boat.

FIG. 5 is an enlarged side view showing an internal configuration of an electric propulsion device.

FIG. 6 is a top view showing a configuration of a circuit board.

FIG. 7 is a bottom view showing a configuration of the circuit board.

### DETAILED DESCRIPTION OF THE EXAMPLE EMBODIMENTS

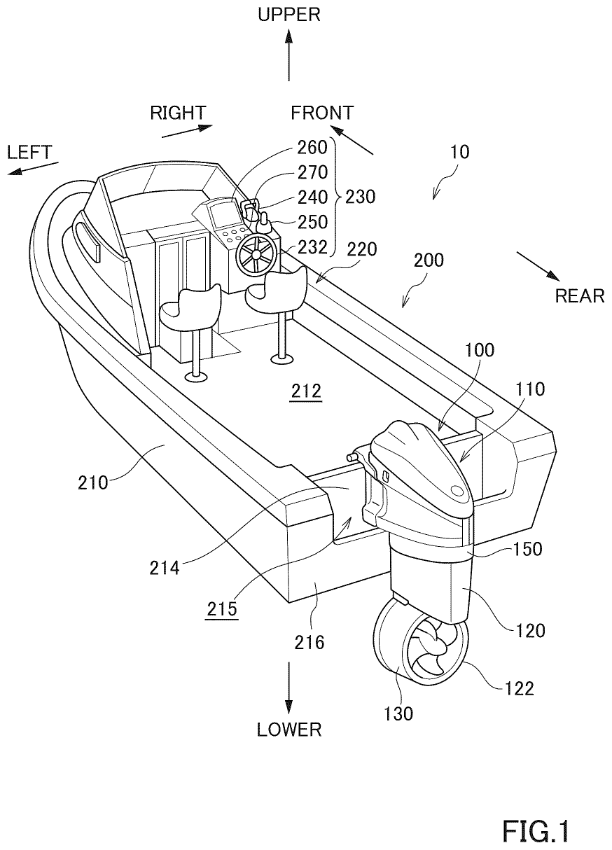

FIG. 1 is a perspective view schematically showing a configuration of a boat 10 according to an example embodiment of the present invention. In FIG. 1 and other figures described below, arrows indicating each direction based on the position of the boat 10 may be shown. Specifically, in each figure, arrows representing front (FRONT), rear (REAR), left (LEFT), right (RIGHT), upper (UPPER), and lower (LOWER) directions may be shown. The front-rear direction, left-right direction, and upper-lower direction (vertical direction) are directions that are orthogonal to each other.

As shown in FIG. 1, the boat 10 includes a boat body 200 and an electric propulsion device 100. The electric propulsion device 100 uses a rim drive system as a drive system of an electric motor 134, which will be described below. The electric propulsion device 100 includes a rim 137, described below, that connects a plurality of blades 131 of a propeller 132. The electric propulsion device 100 is a system in which the driving force of the electric motor 134 is transmitted to, and rotates, the rim 137, rather than being transmitted to a shaft of the propeller 132 described below. The electric propulsion device 100 is an example of an electric boat propulsion device.

The boat body 200 is a section of the boat 10 on which an operator (occupant) boards. The boat body 200 includes a boat main body 210, a pilot seat 220, and a steering unit 230.

A living space 212 is in the boat main body 210. The pilot seat 220 is located in the living space 212. The boat body 200 includes a partition wall 214 and a transom 216. The partition wall 214 partitions the rear side of the living space 212. The transom 216 is located at the rear end of the boat body 200. A space 215 exists between the transom 216 and the partition wall 214 in the front-rear direction.

The steering unit 230 maneuvers the boat 10. The steering unit 230 is located near the pilot seat 220. The steering unit 230 includes a steering wheel 232, a shift/throttle lever 240, a joystick unit 250, a display device 260, and an input device 270.

The steering wheel 232 performs steering operations of the boat 10. The shift/throttle lever 240 performs shift operations and propulsion force change operations of the boat 10. The joystick unit 250 performs steering operations, shift operations, and propulsion force change operations of the boat 10. The display device 260 includes, for example, a liquid crystal display and displays various images related to the boat 10 (such as images for operation). The input device 270 includes, for example, a button to perform operations to change the boat maneuvering mode or the like. The input device 270 may include a light-emitting diode (LED).

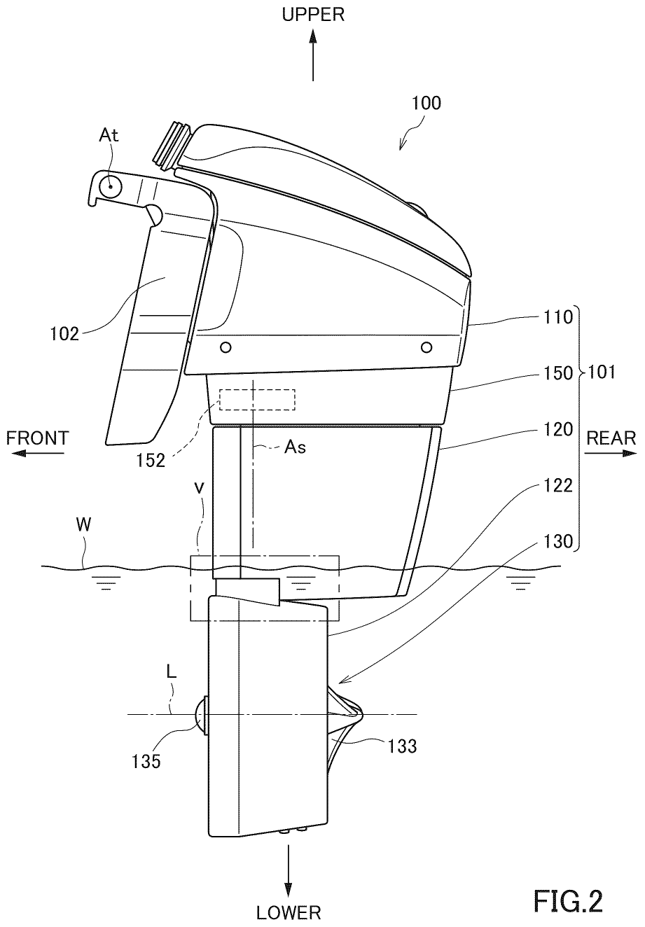

FIG. 2 is a side view showing a configuration of the electric propulsion device 100. The electric propulsion device 100 generates thrust to propel the boat 10. The electric propulsion device 100 is driven by an electric motor 134. The electric propulsion device 100 of the present example embodiment is an outboard motor. Hereinafter, unless otherwise specified, the electric propulsion device 100 in a reference posture will be described. The reference posture is the posture of the electric propulsion device 100 when the boat 10 is cruising (the posture shown in FIGS. 1 and 2), and in which a propeller rotation axis L of the propeller 132, described below, extends in the front-rear direction. Each of the front-rear direction, left-right direction, and upper-lower direction are defined based on the electric propulsion device 100 in the reference posture.

The electric propulsion device 100 is attached to the transom 216 located at the rear portion (stern) of the boat body 200 (see FIG. 1). The electric propulsion device 100 includes a propulsion device main body 101 and a suspension device 102.

The propulsion device main body 101 includes a cowl 110, a middle housing 150, a lower housing 120, a duct 122, and a drive unit 130.

The cowl 110 is located at an upper portion of the electric propulsion device 100. The cowl 110 is a cover that accommodates various wiring and the like.

The middle housing 150 is located below the cowl 110 in the electric propulsion device 100. The middle housing 150 is a cover that accommodates a steering device 152 and an SCU 154, described below, various wiring, and the like.

The lower housing 120 is located below the middle housing 150 in the electric propulsion device 100. The lower housing 120 is a cover that accommodates an MCU 139, described below, various wiring, and the like. The lower housing 120 is attached to the middle housing 150 so as to be rotatable around a steering shaft As extending in the upper-lower direction.

The duct 122 is located below the lower housing 120 in the electric propulsion device 100. The duct 122 is a tubular body extending in the front-rear direction. The duct 122 is located at a position lower than a water surface W in the reference posture (see FIG. 2). The drive unit 130 is located on the radial inner side of the duct 122. On the radial inner side of the duct 122, a stator fin 133 and a bearing 135 are provided (see FIG. 2). The bearing 135 supports a propeller 132, described below, so as to be rotatable about a propeller rotation axis L. The stator fin 133 includes a plurality of fins (for example, three fins). The plurality of fins are radially arranged around the bearing 135. The plurality of fins are arranged at equal intervals around the propeller rotation axis L. The plurality of fins are fixed to the duct 122. The plurality of fins are provided behind the propeller 132 so as to protrude rearward from the duct 122 (see FIGS. 1 and 2).

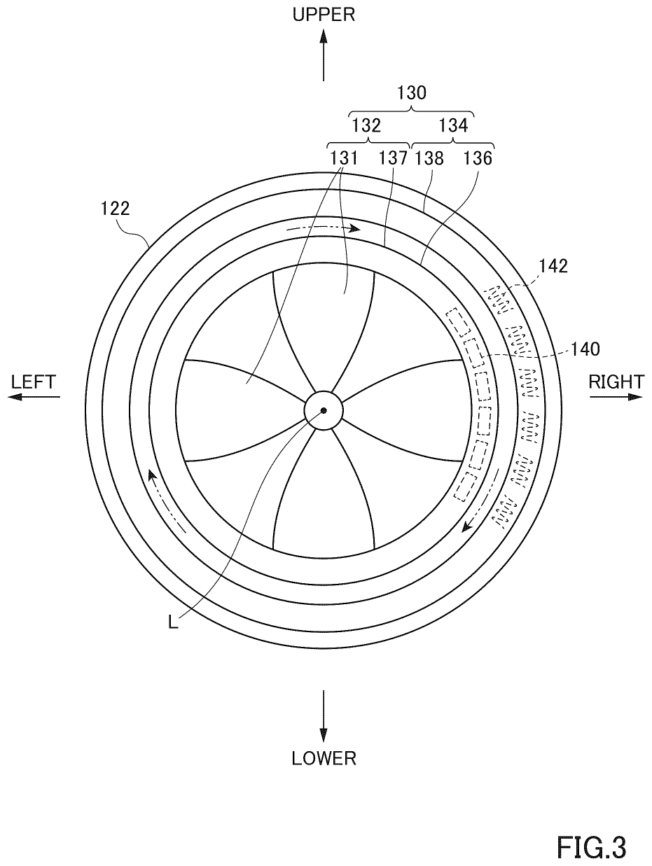

FIG. 3 is a schematic diagram showing the configuration of the drive unit 130. The drive unit 130 generates thrust to propel the boat 10. The drive unit 130 includes the propeller 132 and the electric motor 134.

The propeller 132 is a rotating body including a plurality of blades 131. The propeller 132 generates thrust as a result of rotating. The propeller 132 is located on the radial inner side of the duct 122. The propeller 132 is rotatable about the rotation axis L. The propeller rotation axis L is parallel to the central axis of the duct 122. The entire circumference of the propeller 132 is covered by the duct 122. Specifically, the propeller 132 includes a plurality of (for example, four) blades 131 and the rim 137. The plurality of blades 131 are arranged around the propeller rotation axis L. The rim 137 is an annular member and surrounds the plurality of blades 131. The rim 137 supports the radial outer ends of each of the plurality of blades 131. The rim 137 integrally rotates with the plurality of blades 131 about the propeller rotation axis L.

The electric motor 134 rotates the propeller 132. The electric motor 134 includes a rotor 136 and a stator 138.

The rotor 136 is a tubular body extending in the front-rear direction. The rotor 136 is provided on the rim 137 and is supported so as to be rotatable relative to the duct 122. The rotor 136 rotates about the propeller rotation axis L relative to the stator 138. The propeller 132 is located on the radial inner side of the rotor 136. The propeller 132 is fixed to the rim 137 (rotor 136). The propeller 132 rotates together with the rim 137 (rotor 136). The rotor 136 includes a plurality of permanent magnets 140. In FIG. 3, only one of the plurality of permanent magnets 140 is denoted by a reference sign, and the reference signs of the other permanent magnets 140 are omitted. The plurality of permanent magnets 140 are arranged along the circumferential direction of the rotor 136.

The stator 138 is a tubular body extending in the front-rear direction. The stator 138 is located on the radial outer side of the rotor 136. The stator 138 is located on the same axis as the rotor 136. The stator 138 is fixed to the duct 122. The stator 138 includes a plurality of coils 142. In FIG. 3, only one of the plurality of coils 142 is denoted by a reference sign, and the reference signs of the other coils 142 are omitted. The plurality of coils 142 are arranged along the circumferential direction of the stator 138.

When the plurality of coils 142 are energized, an electromagnetic force is generated that rotates the rotor 136. With such a configuration, the propeller 132 generates a forward propulsion force when the rotor 136 of the electric motor 134 rotates in the forward direction, and generates a rearward propulsion force when the rotor 136 of the electric motor 134 rotates in the reverse direction.

The suspension device 102 suspends the propulsion device main body 101 from the boat body 200. The suspension device 102 rotates the propulsion device main body 101 around a tilt axis At (see FIG. 2). As a result, a tilt operation that rotates the propulsion device main body 101 in the upper-lower direction relative to the boat body 200 is realized.

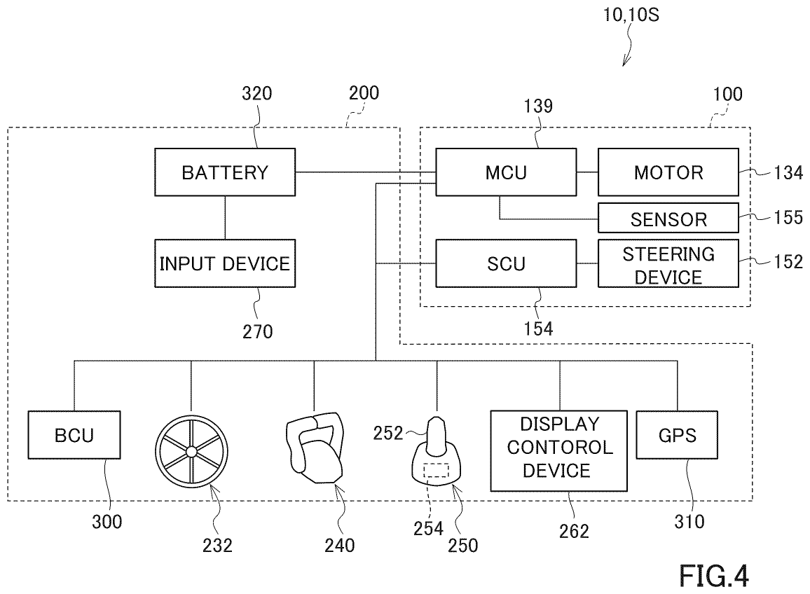

FIG. 4 is a block diagram showing an internal configuration of a boat control system 10S in the boat 10. The components provided in the boat control system 10S are communicably connected to each other, for example, by command line processor (CLP) communication. As shown in FIG. 4, the boat body 200 includes a BCU 300, a GPS 310, a battery 320, and a display control device 262.

A boat control unit (BCU) 300, for example, controls the overall operation of the boat 10 based on signals transmitted from each component of the boat control system 10S. The BCU 300 includes, for example, a CPU, a multi-core CPU, and a programmable device (such as a field programmable gate array (FPGA) or a programmable logic device (PLD)).

A global positioning system (GPS) 310 determines the current position of the boat 10 using signals received from satellites. The battery 320 is a power storage device and supplies power to the electric motor 134 and the input device 270. The display control device 262 controls the display of the display device 260.

The electric propulsion device 100 includes the electric motor 134 described above, a steering device 152, an MCU 139, an SCU 154, and a rotation angle sensor 155.

The steering device 152 controls the steering angle of the boat 10, and is an example of a steering. The steering device 152 is accommodated in the middle housing 150. The steering device 152 includes, for example, an electric motor to steer (not shown) and the steering shaft As extending in the upper-lower direction (see FIG. 2). When the steering angle is changed by the steering device 152, for example, the electric motor rotates the steering shaft As. When the steering shaft As rotates, the lower housing 120 connected to the steering shaft As and the drive unit 130 connected to the lower housing 120 pivot about an axis extending in the upper-lower direction. As a result, the steering angle of the boat 10 is changed.

The motor control unit (MCU) 139 drives the electric motor 134. The MCU 139 is accommodated in the lower housing 120.

The steering control unit (SCU) 154 controls the operation of the steering device 152. The SCU 154 includes, for example, a CPU, a multi-core CPU, and a programmable device (such as a field programmable gate array (FPGA) or a programmable logic device (PLD)). The SCU 154 is accommodated in the middle housing 150.

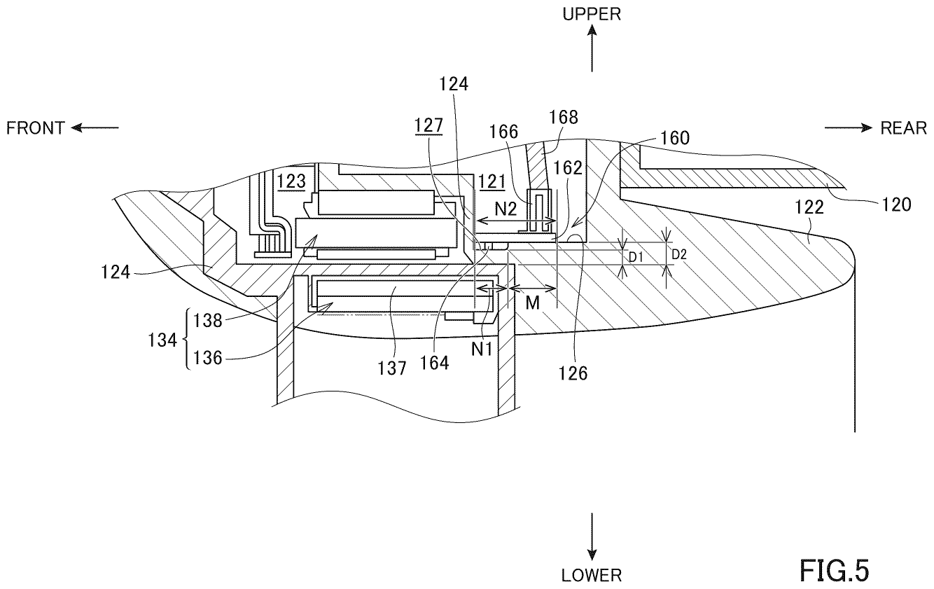

FIG. 5 is an enlarged side view showing an internal configuration of the electric propulsion device 100. FIG. 5 shows an enlarged view of the internal configuration of section V of the electric propulsion device 100 in FIG. 2. The cross-sectional configuration is a cross-section of the internal configuration of section V. Section V is an upper section of the duct 122, and the upper section is joined to the lower housing 120. FIG. 5 shows the upper sections of the electric motor 134 (rotor 136 and stator 138) and the rim 137.

The duct 122 includes an accommodation space 121. The accommodation space 121 is located in the upper section of the duct 122. The accommodation space 121 is located behind the stator 138. The accommodation space 121 is a recess that opens toward the radial outer side of the duct 122. The duct 122 is made of an electrically conductive material (for example, a metal). Therefore, the entire inner wall defining the accommodation space 121 is a conductive wall having electrical conductivity. The conductive wall is electrically continuous with the outer surface of the duct 122. In an example embodiment, the entire duct 122 is made of aluminum to reduce the weight of the electric propulsion device 100. The stator 138 is accommodated in a stator accommodation chamber 123. The accommodation space 121 and the stator accommodation chamber 123 are separated by a partition wall 124.

A circuit board 160 is located on a bottom wall 126 closer to the propeller rotation axis L (rotor 136 side) of the inner wall defining the accommodation space 121. In other words, the circuit board 160 is located on the steering device 152 side of the duct 122. The circuit board 160 is located toward the outer side in the radial direction of the rotor 136 than the duct 122. When viewed in the radial direction of the duct 122 (upper direction view in FIG. 5), a front section of the bottom wall 126 and a rear section of the rotor 136 overlap each other. A recess 127 is provided in the front end section of the bottom wall 126. The recess 127 opens toward the radial outer side of the duct 122.

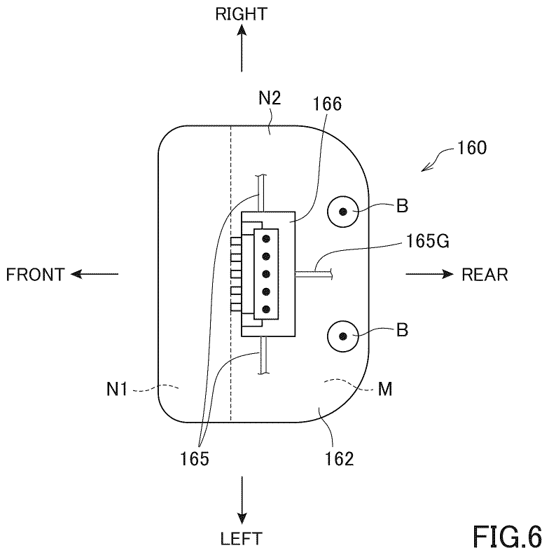

The circuit board 160 includes a substrate 162, the rotation angle sensor 155 described above, and a circuit pattern 165 (see FIG. 6). The substrate 162 has, for example, a rectangular plate shape, and is made of, for example, a resin. The rotation angle sensor 155 is a sensor that outputs a detection signal corresponding to the rotation angle of the rotor 136, and in an example embodiment, includes a plurality of Hall elements 164 and an encoder (not shown).

The surface of the substrate 162 of the circuit board 160 includes a contact region M and non-contact regions N1 and N2. The substrate 162 is located on the bottom wall 126 so as to cover the recess 127. That is, a front section of the substrate 162 is not in contact with the bottom wall 126 (the bottom surface of the recess 127), and a rear section of the substrate 162 is in contact with the bottom wall 126. The contact region M is a region on the inner surface of the substrate 162 facing the radial inner side of the duct 122 and in contact with the bottom wall 126. The first non-contact region N1 is a region of the inner surface of the substrate 162 that faces the recess 127 and is not in contact with the bottom wall 126. The second non-contact region N2 is the entire outer surface of the substrate 162 on the side opposite to the bottom wall 126. The Hall elements 164 and the circuit pattern 165 are not located in the contact region M, and are located in the non-contact regions N1 and N2.

The plurality of Hall elements 164 are located in the first non-contact region N1 of the circuit board 160. The first non-contact region N1 is located at a position that overlaps with the rotor 136 when viewed in the radial direction of the duct 122 (upper-lower direction view in FIG. 5). The contact region M is located at a position shifted in a direction along the propeller rotation axis L (rear direction) with respect to the rotor 136 when viewed in the radial direction of the duct 122.

A front section of the substrate 162 overlaps with the rotor 136 when viewed in the radial direction of the duct 122 (upper-lower direction view). The circuit board 160 is located at a position overlapping with the stator 138 when viewed in a direction along the propeller rotation axis L. Specifically, the circuit board 160 is located on the rear side of the stator 138.

Of the bottom wall 126, a wall thickness D1 of a non-contact section opposite the non-contact region N1 of the circuit board 160 is thinner than a wall thickness D2 of a contact section opposite the contact region M (see FIG. 5). In this way, because the wall thickness D1 of the non-contact section is relatively thin, the distance between the Hall elements 164 and the rotor 136 is shortened.

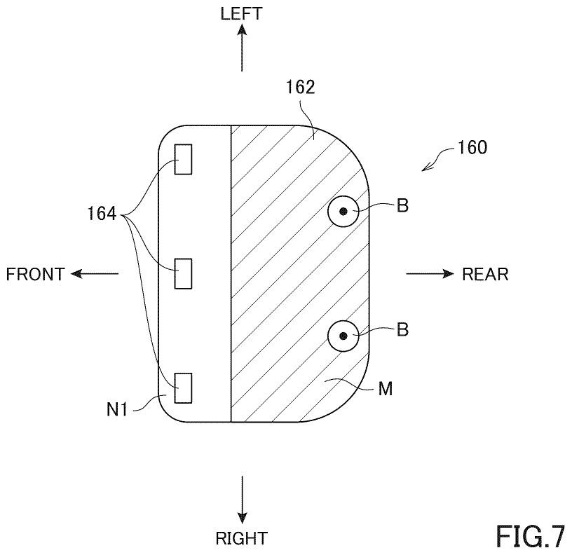

FIG. 6 is a top view showing the configuration of the circuit board 160, and FIG. 7 is a bottom view showing the configuration of the circuit board 160. As shown in FIGS. 6 and 7, the area of the contact region M on the lower surface of the circuit board 160 is larger than the area of the first non-contact region N1. The lower surface of the circuit board 160 is an example of one surface of the circuit board.

The circuit board 160 (substrate 162) is fixed to the bottom wall 126 via a plurality of fasteners B (such as bolts). The plurality of fasteners B extend through the contact region M of the circuit board 160, are screwed into the bottom wall 126, and join the circuit board 160 and the bottom wall 126. In an example embodiment, at least one of the plurality of fasteners B is conductive. The at least one fastener B is made of metal. Of the circuit pattern 165 on the circuit board 160, a ground pattern 165G is electrically connected to the bottom wall 126 via the conductive fastener B. The duct 122 functions as a ground line for the circuit board 160.

The plurality of Hall elements 164 are located at the front end portion of the circuit board 160. The plurality of fasteners B are located at a rear portion of the circuit board 160. That is, the Hall elements 164 and the fasteners B are located on opposite sides of each other on the circuit board 160.

A connector 166 is provided on the upper surface of the circuit board 160. The connector 166 is located in a region opposite the contact region M. The connector 166 electrically connects the circuit pattern 165 on the circuit board 160 and a cable 168. The cable 168 includes, for example, a power supply line to supply power to the circuit board 160, a signal line to output detection signals from the rotation angle sensor 155, and the like. The upper surface of the circuit board 160 is an example of another surface of the circuit board.

As described above, the boat 10 of the present example embodiment includes the cylindrical duct 122, the propeller 132 rotatably supported inside the duct 122, and the electric motor 134 that rotates the propeller 132 relative to the duct 122. The propeller 132 includes the plurality of blades 131 arranged around the propeller axis L extending along the central axis of the duct 122, and the cylindrical rim 137 that surrounds the plurality of blades 131. The electric motor 134 rotates the propeller 132 relative to the duct 122. The electric motor 134 includes the stator 138 provided on the duct 122 and the rotor 136 provided on the rim 137.

The accommodation space 121 is located in the duct 122. The inner wall defining the accommodation space 121 includes the conductive wall (bottom wall 126) having electrical conductivity. The circuit board 160 includes the contact region M that contacts the bottom wall 126 and the non-contact regions N1 and N2 that are not in contact with the conductive wall. The circuit board 160 includes the rotation angle sensor 155 and the circuit pattern 165. The rotation angle sensor 155 outputs a detection signal corresponding to the rotation angle of the rotor 136. The circuit pattern 165 is provided in the non-contact regions N1 and N2 so as to avoid the contact region M. Because the circuit pattern 165 on the circuit board 160 is not in contact with the conductive wall, electrical short-circuiting between the circuit pattern 165 and the conductive wall of the duct 122 is reduced or prevented.

In an example embodiment, the circuit board 160 is located on the steering device 152 side of the duct 122. According to an example embodiment, for example, the circuit board 160 is prevented from being placed underwater compared to a configuration in which the circuit board 160 is located on the side of the duct 122 opposite to the steering device 152. The circuit board 160 is located on the bottom wall 126 on the rotor 136 side of the inner wall defining the accommodation space 121 (see FIG. 5). Because the Hall elements 164 on the circuit board 160 and the rotor 136 are located close to each other, the position detection accuracy of the Hall elements 164 is improved.

In an example embodiment, the circuit board 160 is located on the outside of the rotor 136 in the radial direction of the duct 122. According to an example embodiment, for example, an increase in the size in the front-rear direction of the duct 122 is reduced or prevented compared to a configuration in which the circuit board 160 is located at the same position as the rotor 136 in the radial direction of the duct 122. A front section of the substrate 162 overlaps with the rotor 136 when viewed in the radial direction of the duct 122 (upper-lower direction view of FIG. 5). According to an example embodiment, for example, an increase in the size in the front-rear direction of the duct 122 is reduced or prevented compared to a configuration in which the circuit board 160 does not overlap with the rotor 136 when viewed in the radial direction of the duct 122. The circuit board 160 is located at a position overlapping with the stator 138 when viewed in the front-rear direction. According to an example embodiment, for example, an increase in the size in the radial direction of the duct 122 is reduced or prevented compared to a configuration in which the circuit board 160 is located at a position shifted from the stator 138 when viewed in the front-rear direction.

In an embodiment described above, the plurality of Hall elements 164 are located in the first non-contact region N1 on the inner surface of the circuit board 160. According to an example embodiment, the detection accuracy of the rotation angle of the rotor 136 by the Hall elements 164 is improved, for example, compared to a configuration in which the Hall elements 164 are located on the outer surface of the circuit board 160.

In an example embodiment above, the first non-contact region N1 in which the Hall elements 164 are provided is located at a position overlapping with the rotor 136 when viewed in the radial direction of the duct 122 (upper-lower direction view in FIG. 5). The contact region M that contacts the bottom wall 126 is located at a position shifted in the rear direction with respect to the rotor 136 when viewed in the radial direction of the duct 122. According to an example embodiment, for example, because the distance between the Hall elements 164 and the rotor 136 is shortened compared to a configuration in which the non-contact region in which the Hall elements 164 are provided is located at a position shifted in the front-rear direction with respect to the rotor 136 when viewed in the radial direction of the duct 122, the detection accuracy of the rotation angle of the rotor 136 by the Hall elements 164 is improved.

In an example embodiment described above, of the bottom wall 126, the wall thickness of the non-contact section opposite the non-contact region N1 of the circuit board 160 is thinner than the wall thickness of the contact section opposite the contact region M. Accordingly, for example, a decrease in the detection accuracy of the rotation angle of the rotor 136 by the Hall elements 164 due to the wall interposed between the Hall elements 164 and the rotor 136 is reduced or prevented compared to a configuration in which the wall thickness of the non-contact section is greater than or equal to the wall thickness of the contact section.

In an example embodiment described above, the area of the contact region M on the lower surface of the circuit board 160 is larger than the area of the first non-contact region N1. Accordingly, for example, the circuit board 160 is mounted more stably with respect to the duct 122 compared to a configuration in which the area of the first non-contact region N1 is less than or equal to the area of the contact region M.

In an example embodiment described above, the plurality of fasteners B extend through the contact region M of the circuit board 160, are screwed into the bottom wall 126, and join the circuit board 160 and the bottom wall 126. Accordingly, for example, the contact region M where no circuit pattern is provided is effectively used to fix the circuit board 160 to the duct 122. In an example embodiment described above, the plurality of Hall elements 164 are located at the front end portion of the circuit board 160. The plurality of fasteners B are located at a rear portion of the circuit board 160. Accordingly, a decrease in the detection accuracy of the rotation angle of the rotor 136 by the Hall elements 164 due to electrical influence from the fasteners B is reduced or prevented.

The techniques disclosed herein are not limited to the example embodiments described above, and can be modified in various ways without departing from the gist of the present invention. For example, the following modifications are also possible.

The configurations of the boat 10, the boat control system 10S, and the electric propulsion device 100 in the example embodiments described above are merely examples, and various modifications can be made. For example, in an example embodiment described above, the electric propulsion device 100, which is an outboard motor, is exemplified as the electric boat propulsion device, but the electric boat propulsion device may be, for example, an inboard motor, an inboard/outboard motor, a jet propulsion device, or the like. The electric motor may be a polyphase motor other than a three-phase motor, or may be a DC motor.

In an example embodiment described above, an example of the accommodation space that accommodates the circuit board was a recess located in the upper section of the duct 122 that opens toward the radial direction outer side of the duct 122, but is not limited to this. The accommodation space may be located in a section other than the upper section of the duct 122 (for example, a section near the center in the upper-lower direction of the duct 122 or the like). The accommodation space is not limited to being behind the stator 138 (stator accommodation chamber 123), but may be located in front of or on the radial outer side of the stator 138. The accommodation space may be a recess that opens toward the radial inner side of the duct 122, or a recess opening to the front or rear. The accommodation space is not limited to a recess, and may be a closed space entirely surrounded by an inner wall.

The duct is not limited to the duct 122 entirely made of a conductive material, and for example, may be a duct partially made of a non-conductive material. In other words, at least a portion of the inner wall surface defining the accommodation space that accommodates the circuit board is a conductive wall having conductivity.

In an example embodiment described above, the circuit board 160 was provided on the bottom wall 126, but the circuit board 160 may be located on a section other than the bottom wall 126 of the inner wall defining the accommodation space 121. The circuit board 160 may be located at the same position as the rotor 136 in the radial direction of the duct 122, or may be located on the inner side the rotor 136. An example of the circuit board was the circuit board 160 including the rotation angle sensor 155, but is not limited to this, and the circuit board may be a circuit board that does not include the rotation angle sensor 155 (a circuit board that includes a portion of the MCU 139 or the SCU 154). In an example embodiment described above, a portion other than the front section of the substrate 162 may overlap with the rotor 136 when viewed in the radial direction of the duct 122 (upper-lower direction view), or may not overlap with the rotor 136. In an example embodiment described above, the circuit board 160 may be located at a position shifted from the stator 138 when viewed in the front-rear direction. The circuit board 160 does not have to include the connector 166.

In an example embodiment described above, the Hall elements 164 may be located on the outer surface (the second non-contact region N2) of the circuit board 160 (substrate 162). The number of Hall elements 164 on the circuit board 160 may be one, or a plurality other than three. An example of the rotation angle sensor is not limited to a magnetic sensor such as the Hall elements 164, and may be a sensor that outputs a detection signal corresponding to the rotation angle of the rotor 136 by another method (such as an optical method). An example of the rotation angle sensor is not limited to the rotation angle of the rotor 136, and may be a sensor that detects another object (for example, the steering angle of the duct 122 or the like).

In an example embodiment described above, the non-contact region N1 in which the Hall elements 164 are provided may be located at a position shifted in the front-rear direction with respect to the rotor 136 when viewed in the radial direction of the duct 122 (upper-lower direction view). In an example embodiment described above, the wall thickness of the non-contact section opposite the non-contact region N1 of the circuit board 160 may be greater than or equal to the wall thickness of the contact section opposite the contact region M.

In an example embodiment described above, the area of the first non-contact region N1 in the circuit board 160 may be greater than or equal to the area of the contact region M. In an example embodiment described above, the plurality of fasteners B may extend through the first non-contact region N1 instead of the contact region M of the circuit board 160, be screwed into the bottom wall 126, and join the circuit board 160 and the bottom wall 126. The number of fasteners B that fix the circuit board 160 may be one, or three or more. The plurality of Hall elements 164 and the plurality of fasteners B may be located on the same side of the circuit board 160 in the front-rear direction.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An electric boat propulsion device comprising:
a cylindrical duct including a conductive wall defining an accommodation space;
a propeller rotatably supported in the duct and including a plurality of blades arranged around a propeller axis extending along a central axis of the duct, and a cylindrical rim surrounding the plurality of blades; and
an electric motor to rotate the propeller relative to the duct and including a stator on the duct and a rotor on the rim; and
a circuit board including a contact region that contacts the conductive wall and a non-contact region that does not contact the conductive wall; wherein
the circuit board includes a rotation angle sensor to output a detection signal corresponding to a rotation angle of the rotor, and a circuit pattern in the non-contact region and not in the contact region.

2. The electric boat propulsion device according to claim 1, further comprising:
a steering on a radial outer side of the duct and including a steering shaft, the steering being configured to rotate the duct around the steering shaft; wherein
the circuit board is on the radial outer side of the duct.

3. The electric boat propulsion device according to claim 1, wherein the circuit board is on an outer side of the rotor in a radial direction of the duct.

4. The electric boat propulsion device according to claim 2, wherein the circuit board is on an outer side of the rotor in a radial direction of the duct.

5. The electric boat propulsion device according to claim 1, wherein at least a portion of the circuit board overlaps with the rotor when viewed in a radial direction of the duct.

6. The electric boat propulsion device according to claim 2, wherein at least a portion of the circuit board overlaps with the rotor when viewed in a radial direction of the duct.

7. The electric boat propulsion device according to claim 3, wherein at least a portion of the circuit board overlaps with the rotor when viewed in a radial direction of the duct.

8. The electric boat propulsion device according to claim 1, wherein the circuit board overlaps with the stator when viewed in a direction along the central axis of the duct.

9. The electric boat propulsion device according to claim 2, wherein the circuit board overlaps with the stator when viewed in a direction along the central axis of the duct.

10. The electric boat propulsion device according to claim 3, wherein the circuit board overlaps with the stator when viewed in a direction along the central axis.

11. The electric boat propulsion device according to claim 1, wherein
the rotation angle sensor includes a Hall element;
the circuit board includes an inner surface facing a radial inner side of the duct;
the inner surface includes the contact region and the non-contact region; and
the rotation angle sensor is in the non-contact region.

12. The electric boat propulsion device according to claim 11, wherein
the non-contact region overlaps with the rotor when viewed in a radial direction of the duct; and
the contact region is shifted in a direction along the central axis with respect to the rotor when viewed in the radial direction of the duct.

13. The electric boat propulsion device according to claim 11, wherein a thickness of a non-contact section of the conductive wall opposite the non-contact region where the rotation angle sensor is located is thinner than a thickness of a contact section opposite the contact region.

14. The electric boat propulsion device according to claim 1, wherein
one surface of the circuit board includes the contact region and the non-contact region; and
an area of the contact region on the one surface is larger than an area of the non-contact region.

15. The electric boat propulsion device according to claim 1, further comprising:
a fastener extending through the contact region of the circuit board to join the contact region and the conductive wall.

16. The electric boat propulsion device according to claim 15, wherein
the fastener is conductive; and
a ground pattern of the circuit pattern is electrically connected to the conductive wall via the fastener.

17. The electric boat propulsion device according to claim 16, wherein
the rotation angle sensor includes a Hall element; and
the Hall element is located at one end of the circuit board, and the fastener is located at another end of the circuit board.

18. The electric boat propulsion device according to claim 1, wherein
one surface of the circuit board includes the contact region and the non-contact region; and
a connector is provided on a surface of the circuit board on an opposite side of the contact region.

19. A boat comprising:
a boat body; and
the electric boat propulsion device according to claim 1 on the boat body.

20. An electric boat propulsion device comprising:
a cylindrical duct including a conductive wall defining an accommodation space;
a propeller rotatably supported in the duct and including a plurality of blades arranged around a propeller axis extending along a central axis of the duct, and a cylindrical rim surrounding the plurality of blades;
an electric motor to rotate the propeller relative to the duct and including a stator on the duct and a rotor on the rim; and
a circuit board including a contact region that contacts the conductive wall and a non-contact region that does not contact the conductive wall; wherein
the circuit board includes a circuit pattern in the non-contact region and not in the contact region.
